(19) United States
(12) Patent Application Publication
(10) Pub. No.: US 2013/0139707 A1
(43) Pub. Date: Jun. 6, 2013

(54) Interlocking Strainer and Cooking Apparatus

(71) Applicant: Robert Richard Walling, III, Atlanta, GA (US)

(72) Inventor: Robert Richard Walling, III, Atlanta, GA (US)

(21) Appl. No.: 13/310,778

(22) Filed: Dec. 4, 2011

(51) Int. Cl. A47J 27/00

(52) U.S. Cl. 99/444

(57) ABSTRACT

A system comprising a strainer and a cooking apparatus. The strainer comprises a first interlocking piece, a second interlocking piece, and a straining surface. The second interlocking piece contains a securing mechanism. The cooking apparatus comprises a first interlocking piece and a second interlocking piece. The second interlocking piece contains a receiving mechanism for the securing mechanism.

### FIELD OF THE INVENTION

The invention relates generally to kitchenware and more specifically to straining liquid from food on a cooking surface.

### BACKGROUND OF THE INVENTION

In food preparation, it is common to use liquid or to have liquid accumulate on a cooking surface of a cooking apparatus. Frequently, it is desirable to remove the liquid from the cooking surface while keeping food on the cooking surface. One way this problem is currently addressed in the art is with a separate strainer. However, it may be cumbersome for a single food preparer to negotiate both the cooking apparatus and the strainer. Another solution currently available allows the food preparer to affix a strainer to the top of the cooking apparatus. This solution may be problematic because the strainer often does not fit on the cooking apparatus or the strainer does not effectively cover the opening on the cooking apparatus Accordingly, what is needed in the art is a device that allows a single user to easily and effectively strain liquid from a cooking apparatus.

### SUMMARY OF THE INVENTION

Disclosed herein is a system comprising a strainer and a cooking apparatus. The strainer comprises a first interlocking piece, a second interlocking piece, and a straining surface. The second interlocking piece contains a securing mechanism. The cooking apparatus comprises a first interlocking piece and a second interlocking piece. The second interlocking piece contains a receiving mechanism for the securing mechanism.

Disclosed herein is a system comprising a strainer and a cooking apparatus. The strainer comprises a first interlocking piece, a second interlocking piece, and a straining surface. The second interlocking piece contains a receiving mechanism for a securing mechanism. The cooking apparatus comprises a first interlocking piece and a second interlocking piece. The second interlocking piece contains a securing mechanism.

Disclosed herein is a strainer comprising a first interlocking piece, a second interlocking piece, and a straining surface. The second interlocking piece contains a securing mechanism.

The above described and other features are exemplified by the following figures and detailed description.

### BRIEF DESCRIPTION OF DRAWINGS

Referring now to the figures, which are exemplary embodiments, and wherein the like elements are numbered alike:

FIG. 1 is an overhead view of an exemplary embodiment of a straining portion of the present invention;

FIG. 2 is a side and rotated view of the straining portion in FIG. 1;

FIG. 3 is an overhead view of an alternate embodiment of a straining portion of the present invention;

FIG. 4 is a side and rotated view of the straining portion in FIG. 3;

FIG. 5 is an overhead view of an exemplary embodiment of a cooking portion of the present invention;

FIG. 6 is a side view of the cooking portion in FIG. 5;

FIG. 7 is an overhead view of an alternate embodiment of a cooking portion of the present invention; and

FIG. 8 is a side view of the cooking portion in FIG. 7.

It is noted that the drawings of the embodiments of the invention are not to scale. The drawings are merely schematic representations, not intended to portray specific parameters of the invention. The drawings are intended to depict only typical embodiments of the invention, and therefore should not be considered as limiting the scope of the invention. The invention will be described with additional specificity and detail through the accompanying drawings.

### DETAILED DESCRIPTION

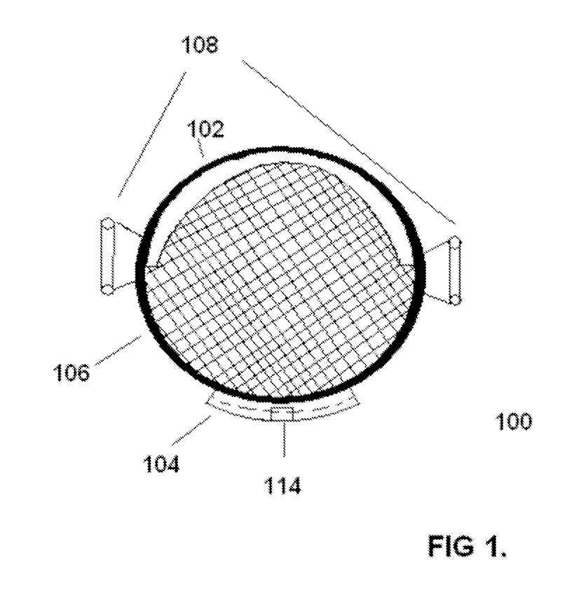

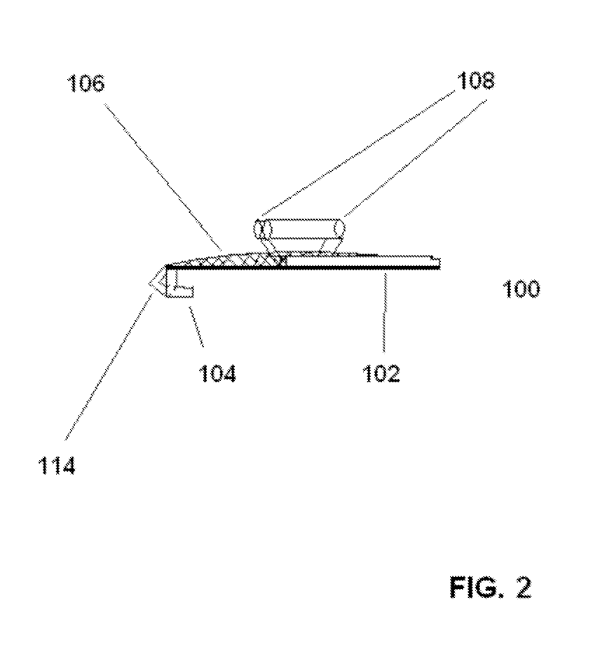

Referring to FIGS. 1 and 2, an exemplary embodiment of a straining portion 100 of the present invention is provided. The straining portion 100 contains a first interlocking piece 102, a second interlocking piece 104, a straining surface 106, and handles 108. The second interlocking piece 104 contains a securing mechanism 114. The straining surface 106, used to strain liquid, may be, for example, a screen or a solid surface with holes. The securing mechanism 114 may be, for example, a clamp, a hook, a latch, or even a snap.

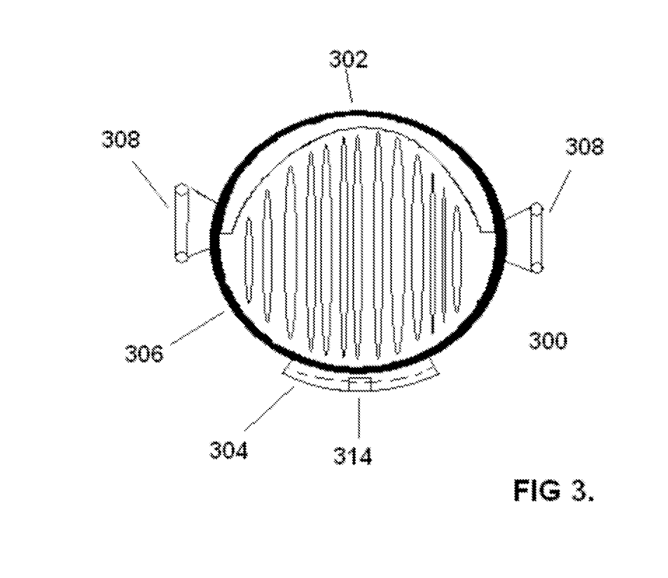

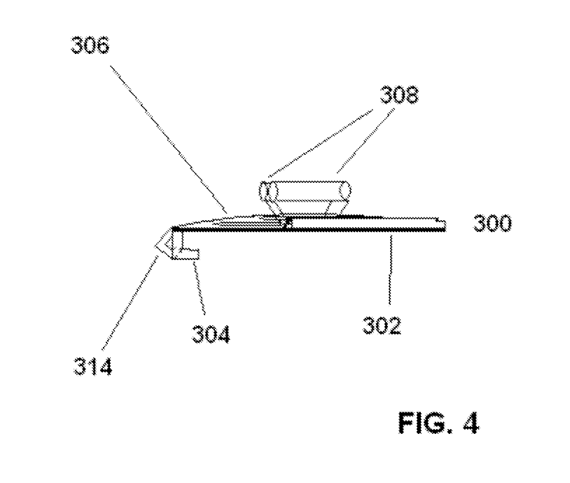

FIGS. 3 and 4 illustrate an alternate embodiment of a straining portion 300 of the present invention. The straining portion 300 contains a first interlocking piece 302, a second interlocking piece 304, a straining surface 306, and handles 308. The second interlocking piece 304 contains a securing mechanism 314. The straining surface 306, used to strain liquid, may be, for example, a screen or a solid surface with holes. The securing mechanism 314 may be, for example, a clamp, a hook, a latch, or even a snap.

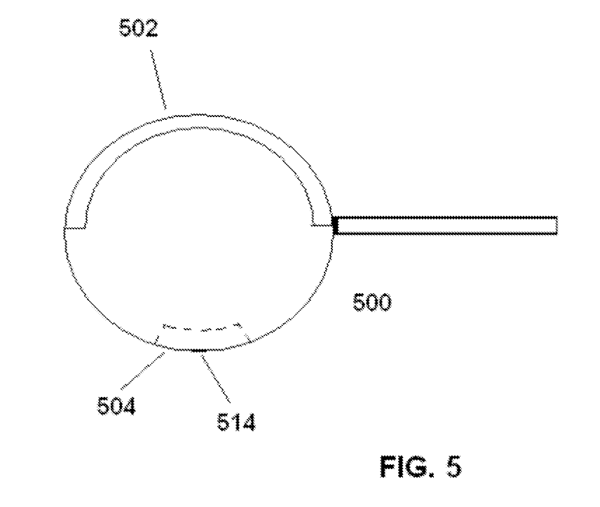

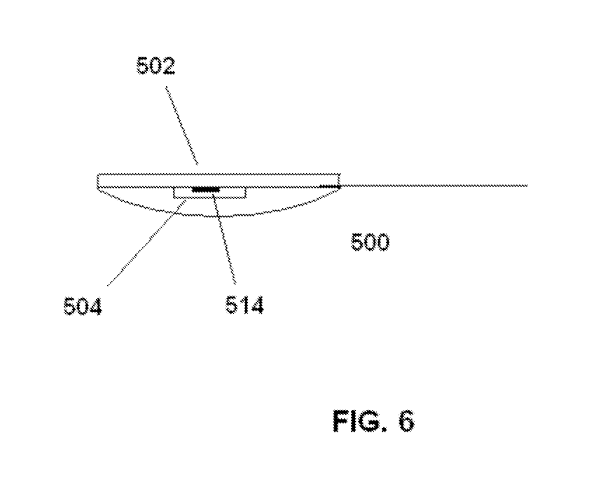

FIGS. 5 and 6 illustrate an exemplary embodiment of a cooking portion 500 of the present invention. The cooking portion 500 may be, for example, a pan or a pot. The cooking portion 500 contains a first interlocking piece 502 and a second interlocking piece 504. The second interlocking piece 504 contains a receiving mechanism 514 for the securing mechanism 114, 314. The first interlocking piece 502 of the cooking portion 500 interlocks with the first interlocking piece 102, 302 of the straining portion 100, 300. The second interlocking piece 504 of the cooking portion 500 interlocks with the second interlocking piece 104, 304 of the straining portion 100, 300. The receiving mechanism 514 receives the securing mechanism 114, 314 to substantially secure the straining portion 100, 300 to the cooking portion 500. The receiving mechanism 514 may be, for example, a bar, a hole, a latch, or even a snap.

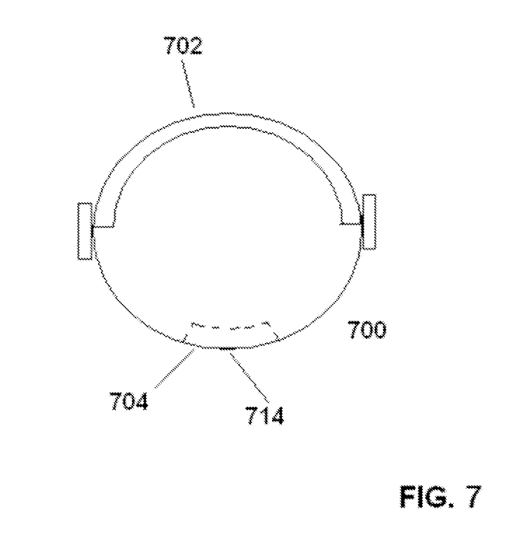

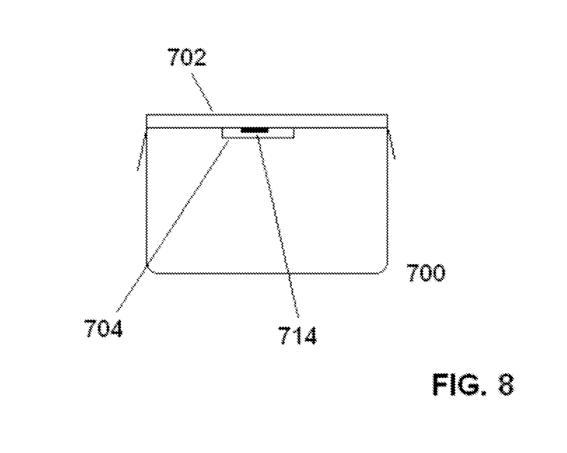

FIGS. 7 and 8 illustrate an alternate embodiment of a cooking portion 700 of the present invention. The cooking portion 700 may be, for example, a pan or a pot. The cooking portion 700 contains a first interlocking piece 702 and a second interlocking piece 704. The second interlocking piece 704 contains a receiving mechanism 714 for the securing mechanism 114, 314. The first interlocking piece 702 of the cooking portion 700 interlocks with the first interlocking piece 102, 302 of the straining portion 100, 300. The second interlocking piece 704 of the cooking portion 700 interlocks with the second interlocking piece 104, 304 of the straining portion 100, 300. The receiving mechanism 714 receives the securing mechanism 114, 314 to substantially secure the straining portion 100, 300 to the cooking portion 700. The receiving mechanism 514 may be, for example, a bar, a hole, a latch, or even a snap.

When the straining portion 100, 300 is substantially secured to the cooking portion 500, 700, a food preparer may easily remove liquid from the cooking portion 500, 700 by tilting the cooking portion 500, 700, so that liquid may flow through the straining portion 100, 300. The straining portion 100, 300 fits securely into the cooking portion 500, 700 so that the straining portion 100, 300 does not substantially alter its position while it is secured to the cooking portion 500, 700.

The straining portion 100, 300 substantially covers the cooking portion 500, 700 to limit the food that may fall out while a food preparer is straining liquid.

In an alternate embodiment, the cooking portion 500, 700 could contain the securing mechanism 114, 314 and the straining portion 100, 300 could contain the receiving mechanism 514, 714.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A system, comprising:
a strainer, comprising:
a first interlocking piece;
a second interlocking piece;
the second interlocking piece containing a securing mechanism; and
a straining surface; and
a cooking apparatus, comprising:
a first interlocking piece;
a second interlocking piece; and
the second interlocking piece containing a receiving mechanism.

2. The system of claim 1, comprising:
the strainer, comprising:
one or more handles.

3. The system of claim 1, comprising:
the strainer, comprising:
the straining surface is a screen.

4. The system of claim 1, comprising:
the strainer, comprising:
the screening surface is a solid surface with holes.

5. The system of claim 1, comprising:
the cooking apparatus is a pan.

6. The system of claim 1, comprising:
the cooking apparatus is a pot.

7. The system of claim 1, comprising:
the strainer, comprising:
the securing mechanism is a clamp; and
the cooking apparatus, comprising:
the receiving mechanism is a bar.

8. The system of claim 1, comprising:
the strainer, comprising:
the securing mechanism is a hook; and
the cooking apparatus, comprising:
the receiving mechanism is a hole.

9. A system, comprising:
a strainer, comprising:
a first interlocking piece;
a second interlocking piece;
the second interlocking piece containing a receiving mechanism; and
a straining surface; and
a cooking apparatus, comprising:
a first interlocking piece;
a second interlocking piece; and
the second interlocking piece containing a securing mechanism.

10. The system in claim 9, comprising:
the strainer comprising:
one or more handles.

11. The system of claim 9, comprising:
the strainer, comprising:
the straining surface is a screen.

12. The system of claim 9, comprising:
the strainer, comprising:
the screening surface is a solid surface with holes.

13. The system of claim 9, comprising:
the cooking apparatus is a pan.

14. The system of claim 9, comprising:
the cooking apparatus is a pot.

15. The system of claim 9, comprising:
the strainer, comprising:
the receiving mechanism is a bar; and
the cooking apparatus, comprising:
the securing mechanism is a clamp.

16. The system of claim 9, comprising:
the strainer, comprising:
the receiving mechanism is a hole; and
the cooking apparatus, comprising:
the securing mechanism is a hook.

17. A strainer, comprising:
a first interlocking piece;
a second interlocking piece;
the second interlocking piece containing a securing mechanism; and
a straining surface.

18. The strainer in claim 17, comprising:
one or more handles.

19. The strainer in claim 17, comprising:
the straining surface is a screen.

20. The strainer in claim 17, comprising:
the screening surface is a solid surface with holes.
